(19) United States
(12) Patent Application Publication
(10) Pub. No.: US 2014/0115661 A1
(43) Pub. Date: Apr. 24, 2014

(54) USER AUTHENTICATION METHOD AND SYSTEM FOR USING WEB MULTI CONTENTS

(71) Applicant: Electronics and Telecommunications Research Institute, Daejeon (KR)

(72) Inventor: Jae Hoon NAH, Daejeon (KR)

(73) Assignee: Electronics and Telecommunications Research Institute, Daejeon (KR)

(21) Appl. No.: 14/028,011

(22) Filed: Sep. 16, 2013

(30) Foreign Application Priority Data
Oct. 22, 2012 (KR) 10-2012-0117490
Mar. 27, 2013 (KR) 10-2013-0032906

(51) Int. Cl. G06F 21/31

(52) U.S. Cl. CPC G06F 21/31
USPC 726/2

(57) ABSTRACT

The present invention relates to an information protection technology for management of a web mashup content authority. An exemplary embodiment of the present invention provides a user authentication method for using a web multi content, which includes: confirming whether to include authority information of a user for at least one content to request a domain which supplies the content to verify an authority of the user; performing authentication for the user who wants to use the content; verifying whether a request of the user to use the content is within an authenticated authority; and decoding the content to be supplied. According to the present invention, in a web service environment where only one protocol is used by the same origin policy, access control for data convergence is provided. In a web convergence service environment, a modification or plagiarism of a content (data or code) is prevented in advance.

### CROSS-REFERENCE TO RELATED APPLICATIONS

This application claims priority to and the benefit of Korean Patent Application No. 10-2012-0117490 filed on Oct. 22, 2012 and 10-2013-0032906 filed on Mar. 27, 2013 in the Korean Intellectual Property Office, the entire contents of which are incorporated herein by reference.

### TECHNICAL FIELD

The present invention relates to an information protection technology for management of a web mashup content authority, and more specifically, to an authentication method for using web multi contents.

### BACKGROUND ART

A same origin policy in a web service environment is an important security concept for a programming language for a browser such as a Java script. This policy gives an authority which allows a script which is performed in a web page based on the same source (domain or site) to access a method and an attribute of the other party but does not allow a page of the other source (domain or site) to access the method and the attribute.

This method plays an important role to exclusively manage the access to contents (data and code) between different domains on an HTTP protocol to prevent confidentiality and integrity of data from being damaged. However, it is difficult to manage authorities for different contents in an environment where the contents from a plurality of web domains are converged.

### SUMMARY OF THE INVENTION

The present invention has been made in an effort to suggest a method which controls authority management for a convergence content by applying a multiple authentication mechanism to multiple origin contents which are not processed by the same origin policy when processing the multi contents in a web mashup (convergence) document.

An exemplary embodiment of the present invention provides a user authentication method for using a web multi content, which includes: confirming whether to include authority information of a user for at least one content to request a domain which supplies the content to verify an authority of the user; performing authentication for the user who wants to use the content; verifying whether a request of the user to use the content is within an authenticated authority; and decoding the content to be supplied.

When the authority information of the user for the content is provided in advance, the content is decoded to be supplied.

The requesting of verification of the authority may provide information for a multi authentication processing to a mashup server in order to request the verification of the user authority when multi authentication information is requested to use the multi contents.

In the performing of the authentication, an authentication center for the content may perform the authentication on the user and inquire a policy server for the content whether the request of the user to use the content is within an authenticated authority.

In the verifying, if a negotiation with a policy server for the other content is required when using the content, the verification may be performed through the negotiation between policy servers.

In the verifying, the verification result of the policy server may be replied to the authentication center.

In the providing, the content may be decoded to be provided using a usage authority or usage restriction information, and a decoded key for the content received from the authentication center.

Another exemplary embodiment of the present invention provides a user authentication system for using a web multi content, which includes: a user terminal which confirms whether to include authority information of a user for at least one content to request a domain which supplies the content to verify an authority of the user; an authentication center which performs authentication for the user who wants to use the content; a policy server which verifies whether a request of the user to use the content is within an authenticated authority; and a mashup server which provides information for decoding the content.

If the authority information of the user for the content is provided in advance, the mashup server may decode the content to provide the decoded content.

If multi authentication information is requested in order to use the multi contents, the user terminal may supply information for processing multi authentication to the mashup server to request the verification of the user's authority.

The authentication center for the content may perform authentication on the user and inquire a policy server for the content whether the usage request of the user is within the authenticated authority.

When negotiation with a policy server for another content is required to use the content, the policy server may verify the authority through the negotiation between the policy servers.

The policy server may reply the verification result to the authentication center.

The mashup server may provide the usage authority, usage limit information, and a decoding key for the content which is received from the authentication center.

According to the present invention, in a web service environment where only one protocol is used by the same origin policy, access control for data convergence is provided. In a web convergence service environment, a modification or plagiarism of a content (data or code) is prevented in advance.

A protocol such as a CORS (cross origin resource sharing) is limited in browsing for usage of the content and a simple processing in the environment which uses a single protocol, but the suggested method may allow authentication and access control for the usage of the content at an end of an upper level of an HTTP so as to variously provide an application protocol on the HTTP.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

FIG. 1 is a view illustrating an infra configuration in which a content is converged according to an exemplary embodiment of the present invention.

FIG. 2 is a flowchart illustrating a user authentication method for using web multi contents according to an exemplary embodiment of the present invention.

FIG. 3 is a detailed flowchart illustrating a user authentication method for using web multi contents according to an exemplary embodiment of the present invention.

FIG. 4 is a view illustrating a multi authentication structure which performs a user authentication method for using web multi contents according to an exemplary embodiment of the present invention.

FIG. 5 is a view illustrating a structure of a protocol which transmits information in a web environment according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following description illustrates only a principle of the invention. Therefore, those skilled in the art may implement the principle of the invention and create various devices within a concept and a scope of the invention even though not clearly described or illustrated in the specification. It is understood that all conditional terminologies and exemplary embodiments described in the specification are apparently intended only for understanding the concept of the invention but the invention is not limited to specifically described exemplary embodiments and status.

The above objects, features, and advantages will be more obvious from the detailed description with reference to the accompanying drawings, and the technical spirit of the present invention may be easily implemented by those skilled in the art. However, in describing the present invention, if it is considered that specific description of related known configuration or function may cloud unnecessarily the gist of the present invention, the detailed description thereof will be omitted. Hereinafter, an exemplary embodiment of the present invention will be described in detail with reference to the accompanying drawings.

Due to a web service convergence, fixed mobile convergence and a mobile service are also gradually converged by a web. One of main features is service convergence. In such an infra structure, data is not only simply converged but also combined with a code. In order to smoothly provide such a service, authentication of an author for the contents configured by data and a code and a scope of an authority for the usage need to be clear.

In the web service environment, the same origin policy plays an important role to exclusively manage access to contents (data and code) between different domains on an HTTP protocol to prevent the confidentiality and integrity of data from being damaged. However, in an environment where contents are converged from a plurality of web domains, it is difficult to manage authorities for different contents.

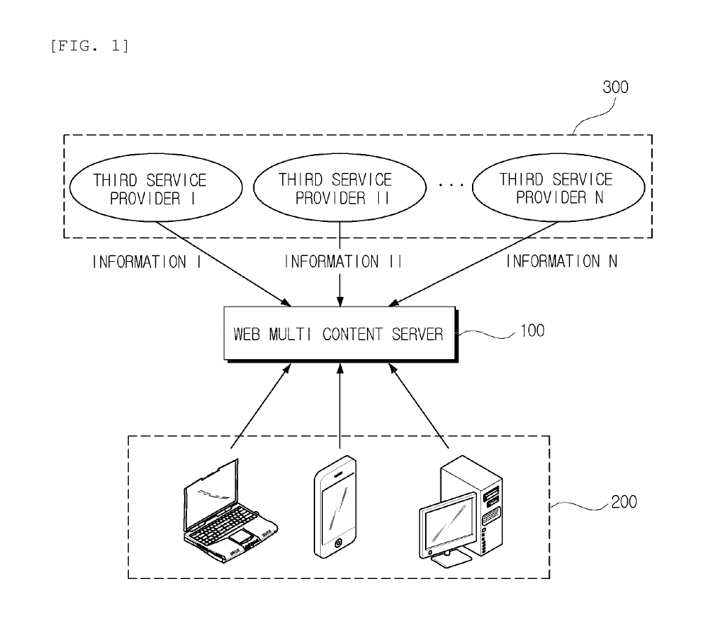

Examples of convergence of contents will be described with reference to FIG. 1. FIG. 1 is a view illustrating an infra configuration in which contents are converged according to an exemplary embodiment of the present invention. Referring to FIG. 1, convergence of web contents is established by a web multi content server 100, a plurality of third service providers 300 which provides information to the web multi content server, and a user terminal 200 which accesses the web multi content server 100.

For example, the web multi content server 100 is supplied with contents from a third service provider 300 (a web site) which provides map, real estate, and photograph services without having its own content and provides a convergence service which provides real estate information on the map and also provides an advertizing service using a photograph based on the real estate information, through the user terminal 200. In this situation, if real estate information which is exclusively differentiated is provided to a minority of users, a mashup web multi content service also needs to follow the policy. That is, if access to the information which is differentiated for the real estate information is limited to the minority, a unit for providing the information needs to be provided to the user who wants the information.

Hereinafter, a method which controls authority management for a convergence content by applying a multiple authentication mechanism to multiple origin contents which are not processed by the same origin policy when processing the multi contents in a web mashup (convergence) document in this environment will be described with reference to the drawing.

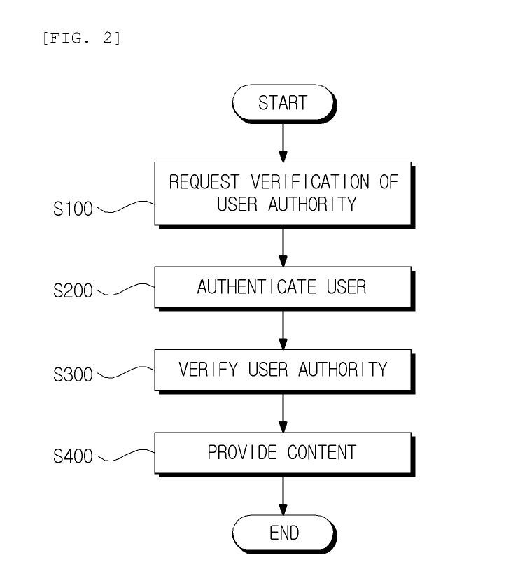

FIG. 2 is a flowchart illustrating a user authentication method for using web multi contents according to an exemplary embodiment of the present invention. Referring to FIG. 2, the user authentication method for using web multi contents according to the exemplary embodiment includes a step of requesting verification of a user authentication (S100), a user authentication step (S200), a user authority verification step (S300), and a content providing step (S400).

In the step of requesting verification of a user authentication (S100), it is confirmed whether authority information of a user for at least one content is provided and verification of a user authority is requested to a domain which provides the contents.

In the user authentication step (S200), the authentication for a user who wants to use the content is performed and if the user is authenticated, in the user authority verification step (S300), it is verified whether the request of the user for usage of the content is within an authenticated authority.

In the content providing step (S400), if there is an authority, the content is decoded to provide the content to the user terminal 200.

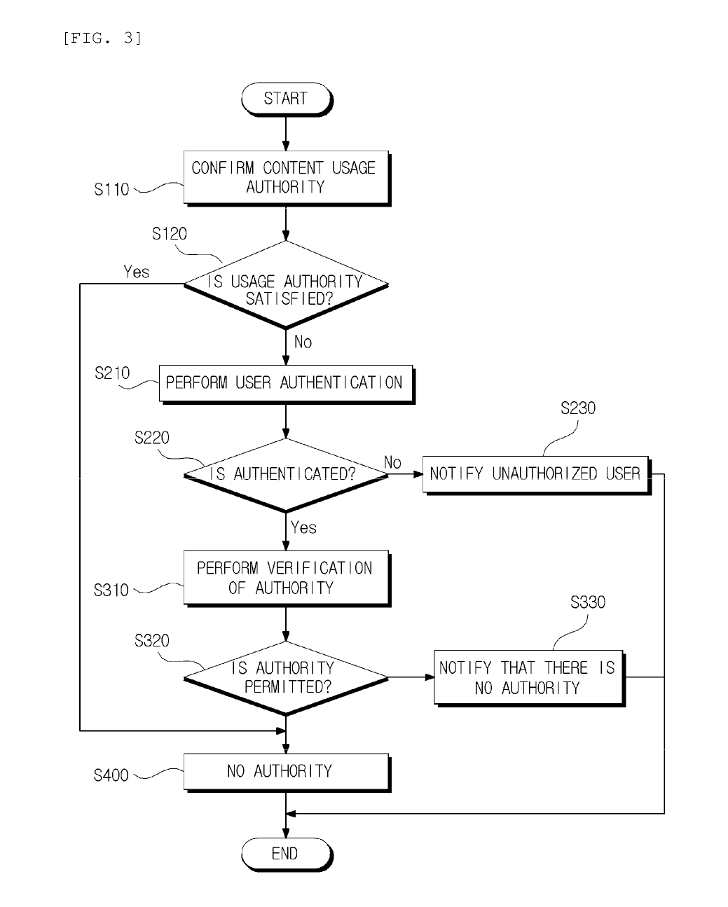

Hereinafter, the user authentication method for using web multi contents will be described in detail with reference to FIG. 3.

FIG. 3 is a detailed flowchart illustrating the user authentication method for using web multi contents according to an exemplary embodiment of the present invention, and the method includes a content usage authority confirming step (S110), a step of confirming whether a usage authority is satisfied (S120), a user authenticating step (S210), a step of confirming whether to be authenticated (S220), an unauthorized user notifying step (S230), an authority verifying step (S310), a step of confirming whether to permit the authority (S320), a step of notifying that there is no authority (S330), and a content providing step (S400).

The user uses the terminal 200 to access a mashup sever which is a site which provides a mashup service.

When the user accesses the mashup server, in the content usage authority confirming step (S110), the mashup server confirms whether to be provided with information on a user authority for a content I in advance.

As a result of the confirmation, if the information on the authority is provided in advance, in the step of confirming whether a usage authority is satisfied (S120), verification on the usage authority which is provided in advance is performed and the content is decoded to be provided. If the usage authority is not provided in advance, the authentication is performed as a first step of confirming a user authority for every content in an inter-working mode.

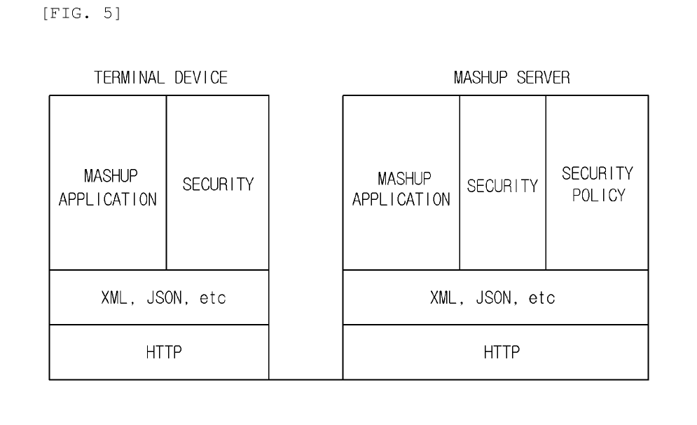

A process after the user authenticating step will be described in detail with reference to FIG. 5.

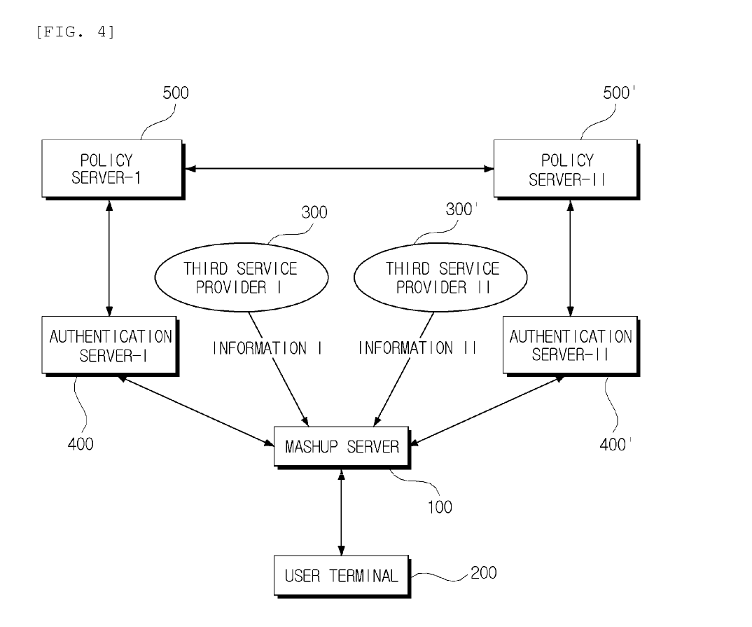

FIG. 4 is a view illustrating a multi authentication structure which performs a user authentication method for using web multi contents according to an exemplary embodiment of the present invention.

In FIG. 4, the multi authentication structure includes a third service provider 300-I which provides a map content and a third service provider 300′-II which provides a real estate content are provided and authentication centers 400 and 400′ and policy servers 500 and 500′ for every provider.

As a web multi content server which provides converged multi contents, a mashup server 100 and a user terminal 200 which receives the multi content are configured.

First, in order to perform authentication, the user terminal 200 sends authentication for using the content and a request for authority verification to a content I providing domain I.

In this exemplary embodiment, the user does not sequentially perform multi authentication in an environment where the multi authentication information for multi contents are requested, but may provide the information using the multi authentication processing to perform the authentication processing instead of the user.

In the user authenticating step (S210), the authentication center I (400) authenticates the user who wants to use the content.

In the step of confirming whether to be authenticated (S220), the authentication result is confirmed. If the authentication is successfully performed, an inquiry is performed to the policy server I (500) in order to verify whether a request to use the content is within the authority. If the authentication has failed, a fact that the user is not authenticated is notified to the mashup server through the unauthorized user notifying step.

In the authority verifying step (S310), the policy server 500 verifies whether the request to use the content is within the authority. Even though the authentication is performed, the user confirms whether the request for the content is a request within the usage authority. For example, if the usage authority is limited only to reading of the content, if the user requests to change the content, the authority is not permitted so that the verification has failed.

Therefore, in the step of confirming whether to permit the authority (S320), the authority is confirmed and if the usage authority is permitted for the content request, the authority permission is transmitted to the authentication center I 400. In contrast, if the authority is not permitted, a fact that there is no authority is notified to the authentication center I 400 through the step of notifying that there is no authority (S330).

In the exemplary embodiment, if negotiation with a policy server of other contents is required in order to use the content, the negotiation is performed between the policy servers and if the negotiation is successfully performed, the policy server I 500 replies whether the negotiation is successfully performed to the authentication center I 400. That is, in order to provide the content to be provided as a converged content by the mashup service, usage authorities for every content to be converged need to be verified so that the policy servers negotiate with each other and the result is replied to the authentication center I.

In the content providing step, the authentication center I transmits a usage authority (read, write, show, cut, or paste) for using the content I, usage limit (time, location, or terminal 200), and decoding key materials to the user terminal 200.

The user terminal 200 checks the transmitted decoding key, the usage authority, and usage limit to decode the content and then provides the decoded content to the user.

If a content which is requested by the user remains, in the exemplary embodiment, when the real estate information is further needed, the content usage authority confirming step, the step of confirming whether a usage authority is satisfied, the user authenticating step, the step of confirming whether to be authenticated, the unauthorized user notifying step, the authority verifying step, the step of confirming whether to permit the authority, the step of notifying that there is no authority, and the content providing step are similarly performed on the content which is provided from the domain II.

Hereinafter, a conceptual structure of the protocol which may substantially transmit the information in the web environment to which the present invention is applied will be described with reference to FIG. 5. Referring to FIG. 5, an http transmission protocol is located on a lower level between a client and a server and an XML protocol which is a format of a document for exchange is mounted thereon.

Based on two basic protocols, map, real estate, and photograph applications which are applications to provide a web service are mounted on the upper level and authentication for providing differentiated information and information protection policy application are mounted at the same level. The information protection policy application is mounted for processing between back end servers for negotiation between servers for the user service request.

According to the present invention described above, in a web service environment which uses only one protocol by the same origin policy, access control for the data convergence is provided.

In the web convergence service environment, a modification or plagiarism of a content (data or code) is prevented in advance.

A protocol such as a CORS (cross origin resource sharing) is limited in browsing for usage of the content and a simple processing in the environment which uses a single protocol, but the suggested method may allow authentication and access control for the usage of the content at an end of a upper level of an HTTP so as to variously provide an application protocol on the HTTP.

In the meantime, the user authentication method for using a web multi content of the present invention may be implemented as a computer readable code in a computer readable recording medium. The computer readable recording medium includes all types of recording devices in which data readable by a computer system is stored.

Examples of the computer readable recording medium include an ROM, an RAM, a CD-ROM, a magnetic tape, a floppy disk, or an optical data storage device and in the computer readable recording medium, a code which is distributed in computer systems connected through a network and readable by a computer in a distributed manner is stored and executed.

Functional programs, codes, and code segments which may implement the present invention may be easily deducted by programmers in the technical field of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A user authentication method for using a web multi content, comprising:
confirming whether to include authority information of a user for at least one content to request a domain which supplies the content to verify an authority of the user;
performing authentication for the user who wants to use the content;
verifying whether a request of the user to use the content is within an authenticated authority; and
decoding the content to be supplied.

2. The method of claim 1, wherein when the authority information of the user for the content is provided in advance, the content is decoded to be supplied.

3. The method of claim 1, wherein the requesting of verification of the authority provides information for a multi authentication processing to a mashup server to request the verification of the user authority when multi authentication information is requested to use the multi contents.

4. The method of claim 1, wherein in the performing of the authentication, an authentication center for the content performs the authentication on the user and inquires a policy server for the content whether the request of the user to use the content is within an authenticated authority.

5. The method of claim 4, wherein in the verifying, if a negotiation with a policy server for the other content is required when using the content, the verification is performed through the negotiation between policy servers.

6. The method of claim 5, wherein in the verifying, the verification result of the policy server is replied to the authentication center.

7. The method of claim 4, wherein in the providing, the content is decoded to be provided using a usage authority or usage restriction information, and a decoded key for the content received from the authentication center.

8. A user authentication system for using a web multi content, comprising:
a user terminal which confirms whether to include authority information of a user for at least one content to request a domain which supplies the content to verify an authority of the user;
an authentication center which performs authentication for the user who wants to use the content;
a policy server which verifies whether a request of the user to use the content is within an authenticated authority; and
a mashup server which provides information for decoding the content.

9. The system of claim 8, wherein if the authority information of the user for the content is provided in advance, the mashup server decodes the content to provide the decoded content.

10. The system of claim 8, wherein if multi authentication information is requested to use the multi content, the user terminal provides information for processing the multi authentication to the mashup server to request the verification of the user authority.

11. The system of claim 8, wherein the authentication center for the content performs authentication on the user and inquires a policy server for the content whether the usage request of the user is within the authenticated authority.

12. The system of claim 11, wherein when negotiation with a policy server for another content is required to use the content, the policy server verifies the authority through the negotiation between the policy servers.

13. The system of claim 12, wherein the policy server replies the verification result to the authentication center.

14. The system of claim 11, wherein the mashup server provides the usage authority, usage limit information, and a decoding key for the content which is received from the authentication center.
